(19) United States
(12) Patent Application Publication
(10) Pub. No.: US 2015/0162939 A1
(43) Pub. Date: Jun. 11, 2015

(54) SYSTEM AND METHOD FOR SIMULTANEOUS VOICE AND DATA COMMUNICATIONS

(71) Applicant: MOTOROLA SOLUTIONS, INC., SCHAUMBURG, IL (US)

(72) Inventors: LEONID TCHVERTKIN, MODI'IN (IL); HAIM FRIEDLANDER, REHOVOT (IL); ARKADY SUBOTSKY, ARAD (IL)

(73) Assignee: MOTOROLA SOLUTIONS, INC., SCHAUMBURG, IL (US)

(21) Appl. No.: 14/099,389

(22) Filed: Dec. 6, 2013

(51) Int. Cl. H04B 1/00; H04B 1/44

(52) U.S. Cl. CPC H04B 1/0064; H04B 1/44; H04W 88/06

(57) ABSTRACT

An antenna configuration for an electronic device routes a receive communication path. The antenna configuration includes a main antenna coupled to a transmit communication path, a diversity antenna, and a switch controller. The switch controller operates to route the receive communication path to a main receiving component of a transceiver from the main antenna when the electronic device is operating in a first operational mode and route the receive communication path to the main receiving component of the transceiver from the diversity antenna when the electronic device is operating in a second operational mode.

### BACKGROUND OF THE INVENTION

An electronic device may be configured with a transceiver to communicate with a communication network. The transceiver is coupled to a main antenna such that the transceiver is capable of connecting to the network on a particular operating frequency of the network in order to perform a communication operation. Accordingly, the main antenna is designed to transmit signals from the transceiver as well as receive signals for the transceiver. In a first example, the electronic device may include a voice operation that performs a voice call in which the communication operation includes transmitting and receiving voice messages on a respective operating frequency. In another example, the electronic device may include a browser operation that allows a user to browse the Internet in which the communication operation includes transmitting and receiving data packets on a respective operating frequency. The electronic device may include a first transceiver used for the voice message communication operation and also include a second transceiver used for the data packet communication operation. The electronic device may also be configured to perform the voice message communication operation and the data packet communication operation concurrently. Therefore, the first transceiver is used for the voice message communication operation at the same time that the second transceiver is used for the data packet communication operation.

The electronic device may further utilize different types of antenna arrangements to perform the communication operations on various frequencies. Specifically, an antenna diversity scheme may be implemented in which two or more antennas are used to improve the quality and reliability of a wireless link. For example, the antenna diversity scheme may relate to a spatial diversity, a pattern diversity, a polarization diversity, a transmit/receive diversity, adaptive arrays, etc. in which multiple antennas are utilized. In another example, the antenna diversity scheme may include the main antenna configured to both transmit and receive signals and a diversity antenna which is configured to only receive signals. With the diversity antenna, the transceiver includes a main transmitting component associated with the main antenna, a main receiving component associated with the main antenna, and a diversity receiving component associated with the diversity antenna.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an electronic device including a pair of transceivers utilizing a respective antenna arrangement in accordance with some embodiments.

FIG. 2 illustrates a first position arrangement of a switch of the Code Division Multiple Access (CDMA) transceiver in accordance with some embodiments.

FIG. 3 illustrates a second position arrangement of the switch of the CDMA transceiver in accordance with some embodiments.

FIG. 4 illustrates a method of utilizing the CDMA transceiver and the CDMA antenna arrangement of FIG. 1 in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

The present invention relates to an antenna configuration for an electronic device comprising a main antenna coupled to a transmit communication path; a diversity antenna; and a switch controller operating to: route a receive communication path to a main receiving component of a transceiver from the main antenna when the electronic device is operating in a first operational mode; and route the receive communication path to the main receiving component of the transceiver from the diversity antenna when the electronic device is operating in a second operational mode.

The exemplary embodiments may be further understood with reference to the following description and the appended drawings, wherein like elements are referred to with the same reference numerals. The exemplary embodiments describe an electronic device having a pair of transceivers and respective antenna arrangements. The electronic device is configured to perform a voice call operation using a first transceiver and a data mode operation using a second transceiver. The first transceiver may include a switch operable in a first position and a second position. The first position of the switch may be used when the electronic device is operating in a first mode of operation while the second position of the switch may be used when the electronic device is operating in a second mode of operation. Specifically, the first mode of operation may be when the electronic device is not executing the voice call operation and the data mode operation concurrently while the second mode of operation may be when the electronic device is executing the voice call operation and the data mode operation concurrently. During the second mode of operation, the first transceiver may increase the isolation between a transmitting and receiving frequency thereof to reduce a resulting intermodulation component from the concurrent execution of the voice call and the data mode application. The transceivers and the antenna arrangements, the isolation, the switch, the first and second positions, the data mode operation, the voice call operation, and a related method will be discussed in further detail below.

With regard to communication networks, specifications indicating the operating frequencies of the communication networks indicate frequency ranges in which various communication operations are performed. For example, a first communication operation may require a first low-band frequency range, a second communication operation may require a second low-band frequency range, a third communication operation may require a first high-band frequency range, and a fourth communication operation may require a second high-band frequency range. When more than one communication operation is executed concurrently or when two transceivers are used in performing respective communication operations, an intermodulation product may result. For example, when the electronic device performs a voice call operation in which voice messages are transmitted and received and performs a data mode operation in which data packets are transmitted and received, the signals associated with the voice messages are received via the respective transceiver component (i.e., the main receiving component associated with the main antenna of the respective transceiver). However, the diversity receiving component of the diversity antenna of the respective transceiver is not used for the receiving of the voice messages. The signals associated with the data packets are received via the further respective transceiver components (i.e., the main receiving component associated with the main antenna of the further respective transceiver and the diversity receiving component associated with the diversity antenna of the further respective transceiver). The transmission frequencies of the voice call transceiver and the data mode operation transceiver may mix and result in a third order intermodulation product that may fall on a receiving frequency of the voice call transceiver. Accordingly, the main receiving component associated with the main antenna of the voice call transceiver may be de-sensed or blocked, which may impair the voice call quality or even cause the voice call to drop.

In a specific example in which a first communication operation associated with the voice call operation and a second communication operation associated with the data mode operation are performed concurrently, the electronic device may include a Simultaneous Voice-Long Term Evolution (SV-LTE) operation that performs the first and second communication operations. While performing the SV-LTE operation, the above described third-order intermodulation product may result in which this intermodulation product may fall in a receiving frequency of the voice call transceiver. Increasing the isolation between the transmitting and receiving components of the voice call transceiver may alleviate the adverse effects to the voice call. As will be described in further detail below, the added isolation may be achieved by routing the signals received in the voice call operation to the main receiving component of the voice call transceiver via reception on the diversity antenna rather than the main antenna.

The following description relates to the SV-LTE operation being performed. Accordingly, the following description relates to an electronic device including a CDMA transceiver and a LTE transceiver (as well as corresponding sub-components). However, it should be noted that the SV-LTE operation, the CDMA transceiver, and the LTE transceiver are only exemplary. Those skilled in the art will understand that the present invention relates to any concurrent operation in which both voice messages and data packets are received concurrently and the third-order intermodulation product results. Therefore, the SV-LTE operation may represent a single operation or two or more operations in which the voice call communication operation and the data packet application communication operation are performed concurrently. In a similar manner, the CDMA transceiver may represent any first transceiver in which the voice call communication operation may be performed while the LTE transceiver may represent any second transceiver in which the data packet communication operation may be performed. It should also be noted that the use of voice messages and data packets is only exemplary. Those skilled in the art will also understand that the present invention relates to any concurrent operation in which any first signals and any second signals are received concurrently and the third-order intermodulation product results.

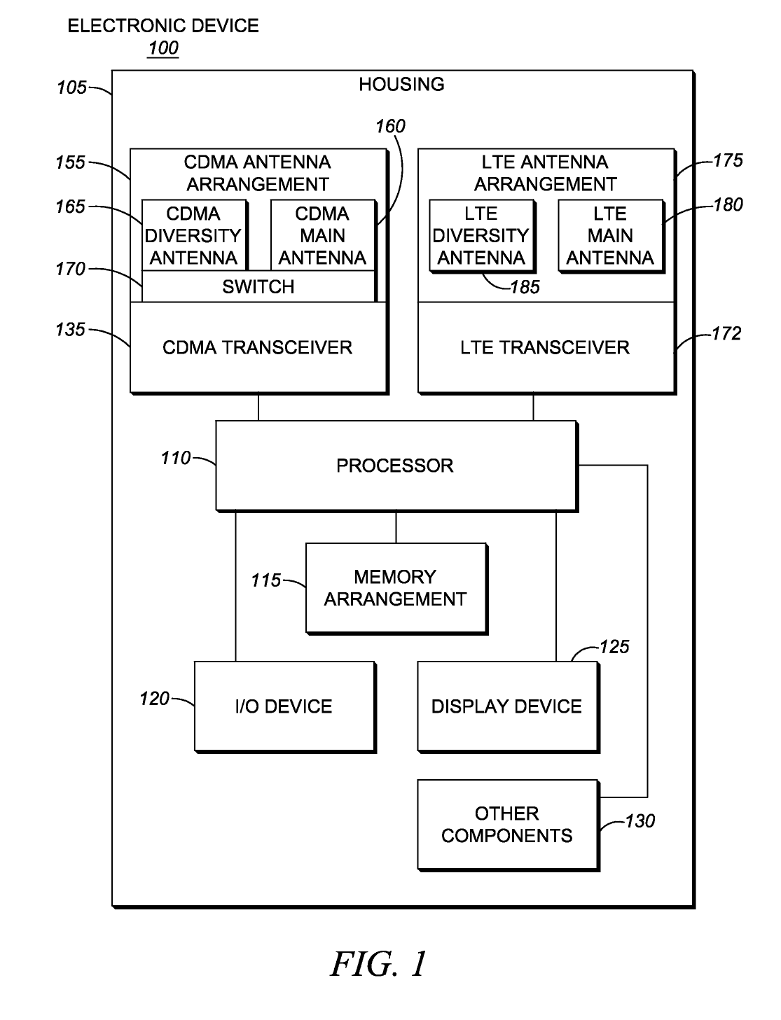

FIG. 1 illustrates an electronic device 100 including a pair of transceivers (a CDMA transceiver 135 and a LTE transceiver 172) utilizing respective antenna arrangements (a CDMA antenna arrangement 155 and a LTE antenna arrangement 175) in accordance with some embodiments. The electronic device 100 may also include a plurality of conventional components. For example, the electronic device 100 may include a housing 105 that at least partially houses a plurality of electronic components such as a processor 110, a memory arrangement 115, an input/output (I/O) device 120, a display device 125, and other components 130 such as a portable power supply, an audio input component, an audio output component, and the like. The electronic device 100 may also include communication lines between the components such as between the processor 110 and each of the memory arrangement 115, the I/O device 120, the display device 125, the other components 130, the CDMA transceiver 135, and the LTE transceiver 172.

The electronic device 100 may be configured to connect to a communication network and communicate with other devices using a data mode and/or a voice call mode. For example, the electronic device 100 may be a mobile unit (e.g., a laptop, a cellular phone, a smart phone, a personal digital assistant, a tablet, a barcode scanner, etc.) including the CDMA transceiver 135 and the LTE transceiver 172 that enables the electronic device 100 to transmit/receive signals from the network via the CDMA antenna arrangement 155 and the LTE antenna arrangement 175, respectively. In another example, the electronic device 100 may represent a stationary device (e.g., a terminal) including the wireless transceivers.

The processor 110 may be configured to execute a plurality of operations. For example, the processor 110 may execute a browser operation in which the data mode operation is utilized such that signals associated with data packets are transmitted and received through a respective network. Specifically, the LTE transceiver 172 with the LTE antenna arrangement 175 may be used for the data mode operation. In another example, the processor 110 may execute a voice call operation in which the voice call operation may be performed such that signals associated with voice messages are transmitted and received through a respective network. Specifically, the CDMA transceiver 135 with the CDMA antenna arrangement 155 may be used for the voice call operation. According to the exemplary embodiments, the processor 110 may also execute a SV-LTE operation. The SV-LTE operation may relate to the electronic device 100 operating simultaneously in the data mode operation (e.g., LTE mode) and in the voice call operation (e.g., circuit switched mode). The LTE mode may provide data services while the circuit switched mode provides the voice service.

According to an exemplary embodiment, the voice call operation of the SV-LTE operation may be operated as a CDMA mode in which various radio communication technologies are used by a channel access method. As a multiple access mode of operation, CDMA may enable several transmitters to send information simultaneously over a single communication channel, thereby allowing several users to share a band of frequencies. To avoid undue interference between the users, CDMA may employ spread-spectrum technology and a special coding scheme where each transmitter is assigned a code. The data mode portion of the SV-LTE operation may be operated as any data transmission protocol. The electronic device 100 may utilize the SV-LTE operation in a variety of manners. Specifically, in a first manner, only the voice call operation may be used; in a second manner, only the data mode operation may be used; and in a third manner, both the voice call operation and the data mode operation may be used concurrently. When the data mode operation and the voice call operation are performed concurrently, the intermodulation product may be experienced using conventional means on a single device such as the electronic device 100.

The exemplary embodiments utilize the CDMA transceiver 135 and the CDMA antenna arrangement 155 for the voice call operation, while the LTE transceiver 172 and the LTE antenna arrangement 175 may be utilized for the data mode operation. The CDMA antenna arrangement 155 may include a CDMA main antenna 160, a CDMA diversity antenna 165, and a switch 170. The CDMA main antenna 160 may be configured to operate with the CDMA transceiver 135 such that signals may be transmitted and/or received. The CDMA diversity antenna 165 may be configured to operate with the CDMA transceiver 135 such that signals may be received. When performing the voice call operation, an initial process may include transmitting and receiving signals via the CDMA main antenna 160 to establish a connection for the voice call. Subsequently, the CDMA main antenna 160 may be used to transmit and receive signals during the voice call. When only the voice call operation is being performed, this may be considered as the standard antenna configuration for the CDMA transceiver 135. However, as will be described in further detail below, particularly with regard to the switch 170, when the voice call operation and the data mode operation are executed concurrently such as in the SV-LTE operation, a concurrent voice/data mode of operation may be used. In this concurrent voice/data mode of operation, the isolation between the signals transmitted and received for the CDMA transceiver 135 may be increased such that the intermodulation product is decreased (or eliminated) when the electronic device 100 is operating in this further mode of operation.

The LTE antenna arrangement 175 may include a LTE main antenna 180 and a LTE diversity antenna 185. The LTE main antenna 180 may be configured to operate with the LTE transceiver 172 such that signals may be transmitted and/or received. The LTE diversity antenna 185 may be configured to operate with the LTE transceiver 172 such that signals may be received. Since the LTE transceiver 172 is used for the data mode operation, the LTE main antenna 180 and the LTE diversity antenna 185 may be used for exchange of signals associated with data packets.

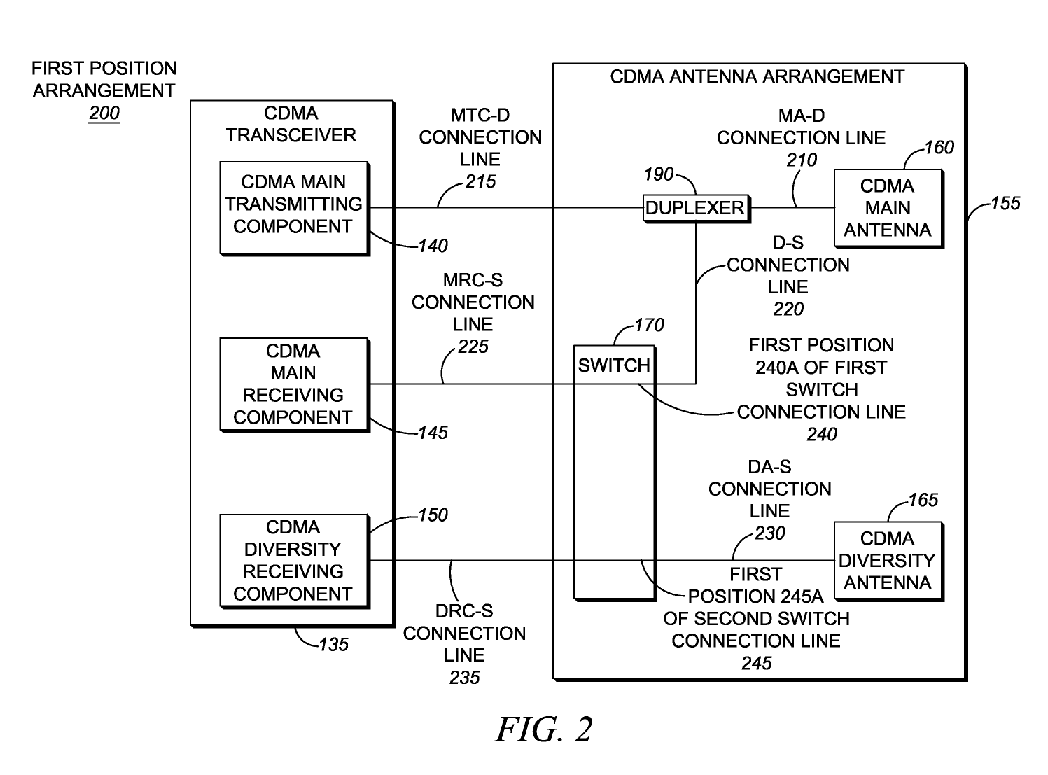

FIG. 2 illustrates a first position arrangement 200 of the switch 170 of the CDMA transceiver 135 in a first position in accordance with some embodiments. Specifically, in the first position arrangement 200, the switch 170 is configured to route signals in a first predetermined manner (as will be described below). As illustrated, the CDMA transceiver 135 may be configured to operate with the CDMA antenna arrangement 155 including the CDMA main antenna 160, the CDMA diversity antenna 165, and the switch 170. Accordingly, the CDMA transceiver 135 may include a CDMA main transmitting component 140, a CDMA main receiving component 145, and a CDMA diversity receiving component 150. The CDMA main transmitting component 140 and the CDMA main receiving component 145 may be associated with the CDMA main antenna 160 when the switch 170 is in the first position.

The first position arrangement 200 also relates to when the communication operations of the voice call operation and the data mode operation are not performed concurrently, therefore no special interference mitigation measures are needed. This may be considered as the standard mode of operation. For example, the voice call operation may be performed using the CDMA transceiver 135 while the data mode operation is not running on the LTE transceiver 172. In another example, the initial process of the voice call operation may be performed in the standard mode of operation, where the power control is performed in open loop mode, and the CDMA transceiver 135 estimates path losses and calculates the required transmit power based on this estimation. It should be noted that the initial process of the voice call operation is performed in the standard mode of operation such that errors into the path loss calculation are not unnecessarily introduced.

The CDMA transceiver 135 and the CDMA antenna arrangement 155 may be configured with various connection lines. As illustrated in FIG. 2, a main antenna (MA)-duplexer (MA-D) connection line 210 may have a first end coupled to a duplexer 190 and a second end coupled to the CDMA main antenna 160. It should be noted that the use of the duplexer 190 is only exemplary and that any bi-directional communication component that enables signals to be forwarded to the CDMA main transmitting component 140 and forwarded from the CDMA main receiving component 145 such that the CDMA main antenna 160 is used by both components may be used. As shown, a main transmitting component (MTC)-duplexer (MTC-D) connection line 215 may have a first end coupled to the duplexer 190 and a second end coupled to the CDMA main transmitting component 140. In this manner, a transmit communication path may be routed between the CDMA main transmitting component 140 and the CDMA main antenna 160 via the MTC-D connection line 215, the duplexer 190, and the MA-D connection line 210. A duplexer-switch (D-S) connection line 220 may have a first end coupled to the duplexer 190 and a second end coupled to the switch 170. A main receiving component (MRC)-switch (MRC-S) connection line 225 may have a first end coupled to the switch 170 and a second end coupled to the CDMA main receiving component 145. A diversity antenna (DA)-switch (DA-S) connection line 230 may have a first end coupled to the CDMA diversity antenna 165 and a second end coupled to the switch 170. A diversity receiving component (DRC)-switch (DRC-S) connection line 235 may have a first end coupled to the switch 170 and a second end coupled to the CDMA diversity receiving component 150.

The duplexer 190 connecting the CDMA main antenna 160, the CDMA main transmitting component 140, and the switch 170 via the MA-D connection line 210, the MTC-D connection line 215, and the D-S connection line 220, respectively, may enable bi-directional communication over a single path. Accordingly, a transmission signal from the CDMA main transmitting component 140 may be routed through the MTC-D connection line 215, to the duplexer 190, to the MA-D connection line 210, and to the CDMA main antenna 160. A reception signal may also be routed from the CDMA main antenna 160, to the MA-D connection line 210, to the duplexer 190, to the D-S connection line 220, and to the switch 170.

The switch 170 may also include connection lines. In the first position arrangement 200 shown in FIG. 2 (e.g., during the standard mode of operation), a first switch connection line 240 may be configured in a first position 240A such that the D-S connection line 220 is connected to the MRC-S connection line 225 while a second switch connection line 245 may be configured in a first position 245A such that the DA-S connection line 230 is connected to the DRC-S connection line 235. In this manner, the first position arrangement 200 may allow for the CDMA main antenna 160 to be coupled to the CDMA main receiving component 145 while the CDMA diversity antenna 165 is coupled to the CDMA diversity receiving component 150. Accordingly, a receive communication path may be routed between the CDMA main receiving component 145 and the CDMA main antenna 160 via the MRC-S connection line 225, the first switch connection line 240 in the first position 240A, the D-S connection line 220, the duplexer 190, and the MA-D connection line 210. A further receive communication path may be routed between the CDMA diversity receiving component 150 and the CDMA diversity antenna 165 via the DRC-S connection line 235, the second switch connection line 245 in the first position 245A, and the DA-S connection line 230.

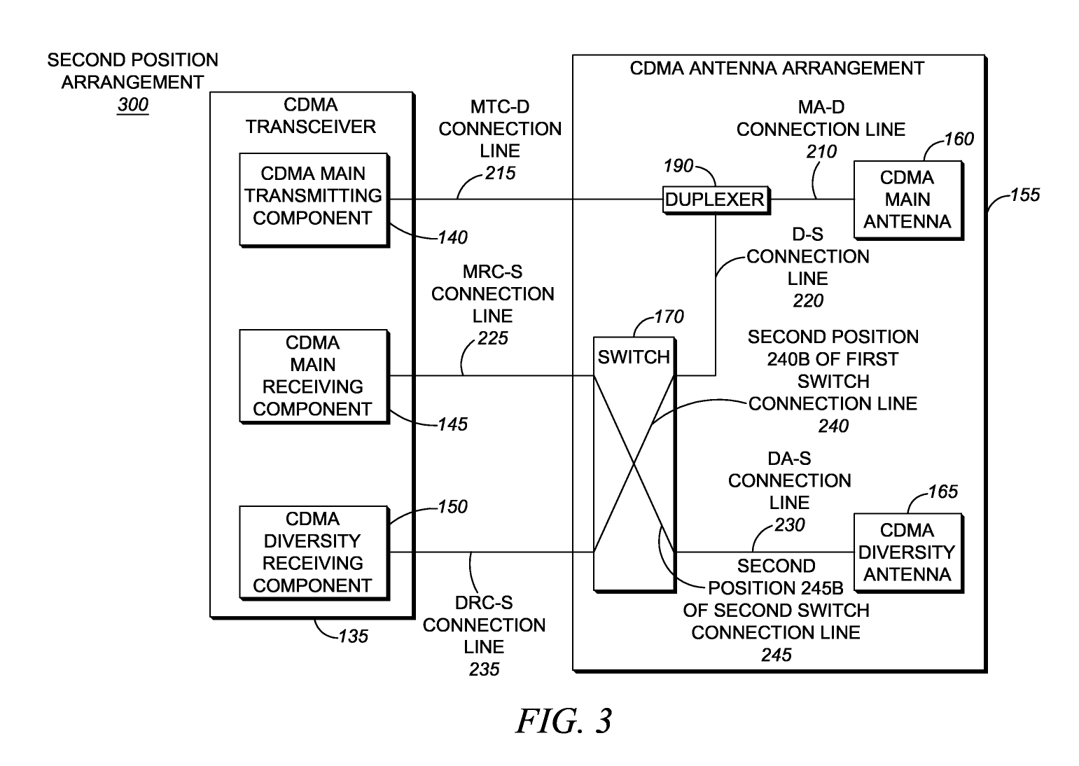

FIG. 3 illustrates a second position arrangement 300 of the switch 170 of the CDMA transceiver 135 in a second position in accordance with some embodiments. Specifically, in the second position arrangement 300, the switch 170 is configured to route signals in a second predetermined manner (as will be described below). The second position arrangement 300 relates to when the communication operations of the voice call operation and the data mode operation such as in the SV-LTE operation is performed concurrently. That is, the voice call operation of the SV-LTE operation may be performed with the CDMA transceiver 135 while the data mode operation may also be performed concurrently by the LTE transceiver 172. The second position arrangement 300 shown in FIG. 3 illustrates how the first switch connection line 240 is moved from the first position 240A to the second position 240B while the second switch connection line 245 is moved from the first position 245A to the second position 245B. The first end of the first switch connection line 240 in the second position 240B may remain connected to the D-S connection line 220. However, the second end of the first switch connection line 240 in the second position 240B may now be connected to the DRC-S connection line 235. The first end of the second switch connection line 245 in the second position 245B may remain connected to the DA-S connection line 230. However, the second end of the second switch connection line 245 in the second position 245B may now be connected to the MRC-S connection line 225. Accordingly, the second position arrangement 300 may allow for the CDMA main antenna 160 to be coupled to the CDMA diversity receiving component 150 while the CDMA diversity antenna 165 is coupled to the CDMA main receiving component 145. Therefore, a receive communication path may be routed between the CDMA main receiving component 145 and the CDMA diversity antenna 165 via the MRC-S connection line 225, the second switch connection line 245 in the second position 245B, and the DA-S connection line 230. A further receive communication path may be routed between the CDMA diversity receiving component 135 and the CDMA main antenna 160 via the DRC-S connection line 235, the first switch connection line 240 in the second position 240B, the D-S connection line 220, the duplexer 190, and the MA-D connection line 210.

The switch 170 may be any type of switch configured to provide the first and second predetermined manners of routing signals. Specifically, the switch 170 may be a radio frequency (RF) switch configured for this purpose. For example, the switch 170 may be a Double Pole Double Throw (DPDT), RF switch. However, it should again be noted that the switch 170 being a DPDT switch is only exemplary and that the switch 170 may be any type of component that allows for the configurations described above to be achieved. For example, a mechanical switch may also be utilized.

It should be noted that the connection lines shown in FIGS. 2 and 3 may include various other components (not shown). For example, various filters may be utilized in order to remove unwanted components or features in the signal. A first filter may be disposed on the MTC-D connection line 215 for the transmission signal from the CDMA main transmitting component 140. A second filter may be disposed on the DA-S connection line 230 for the reception signal from the CDMA diversity antenna 165. Further filters may be disposed on other connection lines. In another example, an amplifier may be utilized to increase the power of a signal. Specifically, an amplifier may be disposed on the MTC-D connection line 215 to increase the power of the transmission signal from the CDMA main transmitting component 140. The amplifier may be disposed in series with the filter on the MTC-D connection line 215.

According to the exemplary embodiments, the first position arrangement 200 and the second position arrangement 300 may be utilized in a dynamic manner as a function of various criteria. That is, dependent upon a variety of factors associated with the criteria, the processor 110 may control the switch 170 such that the first position arrangement 200 may be utilized or control the switch 170 such that the second position arrangement 300 may be utilized. For example, when a non-SV-LTE application is being executed such that only the voice call communication operation or only the data mode communication operation is being performed, the processor 110 may execute a switch control application that enables the use of the first position arrangement 200 for the standard mode of operation (e.g., voice only, data only, initial process of voice call, open loop mode, etc.) but may use the second position arrangement 300 for the further mode of operation (e.g., SV-LTE application that supports concurrent voice and data).

The first position arrangement 200 may relate to utilizing the CDMA transceiver 135 and the CDMA antenna arrangement 155 in a first mode of operation. Specifically, the first mode of operation is the configuration of the switch 170 in which the CDMA main antenna 160 is connected to the CDMA main receiving component 145 and the CDMA diversity antenna 165 is connected to the CDMA diversity receiving component 150 from using the first switch connection line 240 in the first position 240A and the second switch connection line 245 in the first position 245A. This first mode of operation may be utilized for a variety of different operations performed by the processor 110. For example, when the processor 110 is performing an operation utilizing the data mode operation only, the first position arrangement 200 may be utilized. Since the voice call operation is not being performed, the transmission and reception of signals using the LTE transceiver 172 may not generate any intermodulation product. In another example, the processor 110 may be performing calculations in the open loop mode in which the calculation of path loss is determined using the first position arrangement 200 (e.g., the transmission and reception of signals has a balance issue that is critical). This may avoid issues raised from different overall gains of reception and transmission paths that may cause changes in antenna voltage standing-wave ratio (VSWR) from a detuning effect such as from an influence of a user's head, a user's hand, etc. This normally happens in the initial process (e.g., establishing a connection with the base station).

The second position arrangement 300 may relate to utilizing the CDMA transceiver 135 and the CDMA antenna arrangement 155 in a second mode of operation. Specifically, the second mode of operation is the configuration of the switch 170 in which the CDMA main antenna 160 is connected to the CDMA diversity receiving component 150 and the CDMA diversity antenna 165 is connected to the CDMA main receiving component 145 from using the first switch connection line 240 in the second position 240B and the second switch connection line 245 in the second position 245B. This second mode of operation may be utilized for a variety of different operations performed by the processor 110. For example, when the processor 110 is executing the SV-LTE operation utilizing both the data mode operation and the voice call operation concurrently, the second position arrangement 300 may be utilized. A noted problem with the SV-LTE operation is the intermodulation product that results from the interaction between two transmission carriers, namely the CDMA band class (BC) 0 for the voice call (using the CDMA transceiver 135) and the LTE BC13 or BC14 of the data mode (using the LTE transceiver 172). This unwanted intermodulation product may fall in the receiving frequency of the voice call band to cause receiver blocking or desensitization. The magnitude of the intermodulation product depends on the transmission power of the carriers and the third-order intercept point (IP3) of certain components in the transceivers.

To alleviate this intermodulation product, antenna isolation may resolve this unwanted effect. Through the second position arrangement 300 of the exemplary embodiments, additional isolation may be achieved between the CDMA main transmitting component 140 and the CDMA main receiving component 145.

Specifically, the CDMA diversity antenna 165 serves as the receiving portion for the voice call, which is possible since the CDMA diversity receiving component 150 is not used during a voice call. Accordingly, the conventional manner of utilizing the CDMA main antenna 160 as the main receiving element for the CDMA main receiving component 145 is no longer used such that the intermodulation product is decreased or eliminated. For example, the use of the CDMA diversity antenna 165 as the main receiving component of the CDMA antenna arrangement 155 and routing the reception signal of the voice call to the CDMA main receiving component 145, the isolation between the signal being transmitted in the voice call and the signal being received in the voice call is improved. Experimental testing using the second position arrangement 300 compared to a conventional arrangement without the use of the switch 170 have shown that this may result in reducing the intermodulation product by a factor of 2 dB for every additional dB of isolation.

Referring to FIGS. 1 through 3, the processor 110 may execute the switch control application whenever a further application is being executed. Accordingly, the processor 110 may transmit a signal to the switch 170 as determined by the switch control application to place the switch 170 in the first position arrangement 200 or the second position arrangement 300. The memory arrangement 115 may store data related to the position of the switch for an execution of an application. In a first example, the switch control application may be executed automatically in a background capacity. Thus, whenever a communication operation is performed, the switch control application may determine the position to be utilized by the switch 170. In a second example, the switch control application may be executed such that the signal generated for the switch 170 is determined in a manual manner. That is, when the user selects a communication operation to be performed, the switch control application may request the user to select the position of the switch 170.

When the communication operation is performed, the switch control application may reference the data stored in the memory arrangement 115 to determine whether the first position arrangement 200 or the second position arrangement 300 is to be used. As discussed above, when the communication operation relates the standard mode of operation, the first position arrangement 200 may be used while when the communication operation relates to the concurrent voice/data mode of operation, the second position arrangement 300 may be used. The memory arrangement 115 may store this association data such that the switch control application properly manages the use of the switch 170.

It should be noted that the application being executed by the processor 110 may entail the use of both the first position arrangement 200 and the second position arrangement 300. For example, in an initial phase of executing the SV-LTE operation, a pure data mode operation may be utilized. Accordingly, the first position arrangement 200 may be used in the manner discussed above. However, once a connection is established or the pure data mode is no longer in use (e.g., the voice call operation and the data mode operation are simultaneously in use), the second position arrangement 300 may be used in the manner discussed above. Therefore, the use of the first position arrangement 200 and the second position arrangement 300 may also be determined as a function of the phase of execution of the communication operation. The memory arrangement 115 may also store this association data such that the switch control application properly manages the use of the switch 170.

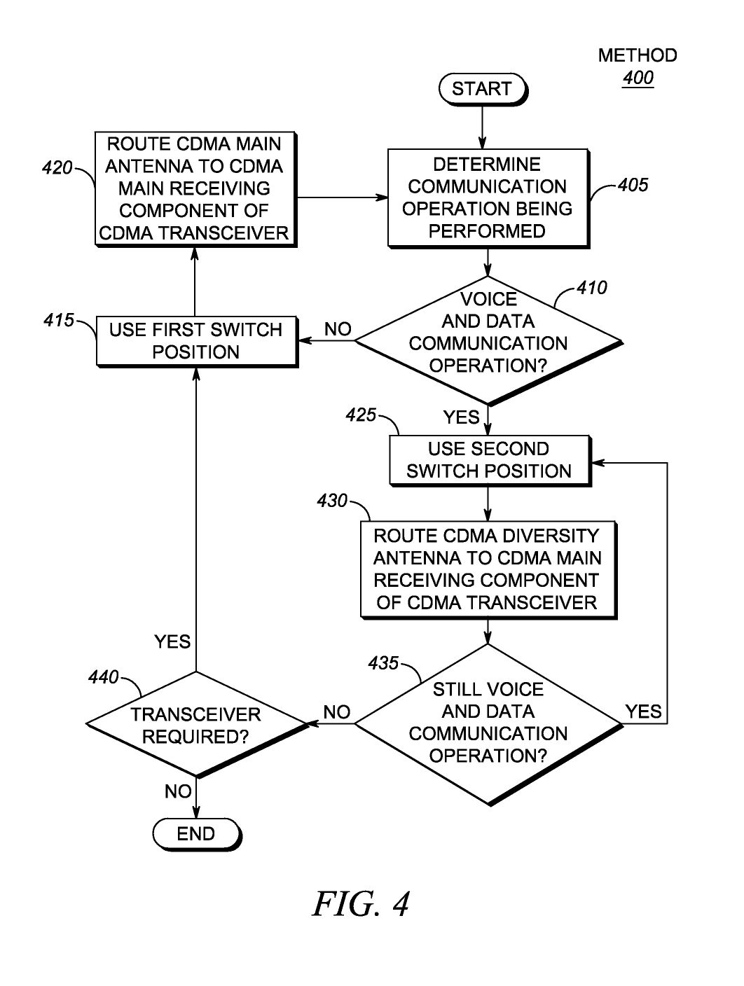

FIG. 4 illustrates a method 400 of utilizing the CDMA transceiver 135 and the CDMA antenna arrangement 155 of FIG. 1 in accordance with some embodiments. The method 400 relates to determining the proper position of the switch 170 between the CDMA transceiver 135 and the CDMA antenna arrangement 155. Specifically, the method 400 determines when the switch 170 will be configured to the first position arrangement 200 or when the switch 170 will be configured to the second position arrangement 300. The method 400 will be described with reference to the electronic device 100 of FIG. 1, the first position arrangement 200 of FIG. 2, and the second position 300 arrangement of FIG. 3.

In 405, the switch control application determines which communication operation is being performed. As discussed above, the processor 110 may perform a plurality of operations in which a first type may be one that utilizes only the data mode operation for data communication while a second type may be one that simultaneously utilizes the data mode operation and the voice call operation. In 410, a determination is made whether the operation being performed includes both the voice call operation and the data mode operation. In a specific example, the determination relates to whether the operation is for the SV-LTE operation.

If 410 determines that the operation being performed only uses the data mode operation, only uses the voice call operation, or otherwise requires the first position (e.g., open loop mode) of the switch 170, method 400 continues to 415. In 415, the first position arrangement 200 is used. Thus, in 420, the CDMA main antenna 160 is connected to the CDMA main receiving component 145 of the CDMA transceiver 135 while the CDMA diversity antenna 165 is connected to the CDMA diversity receiving component 150 of the CDMA transceiver 135. Accordingly, the CDMA diversity antenna 165 may aid in receiving the signals of the operation being performed running in only data mode (if the CDMA transceiver 135 is being used for this purpose). The MU 100 may continue to utilize the first position arrangement 200. The method 400 may return to 405 to determine whether a further operation has been performed.

Returning to 410, if the executed application is determined to be an operation including both the voice call operation and the data mode application, the method 400 continues to 425. In 425, the second position arrangement 300 is used. Thus, in 430, the CDMA diversity antenna 165 is connected to the CDMA main receiving component 145 of the CDMA transceiver 135 while the CDMA main antenna 160 is connected to the CDMA diversity receiving component 150 of the CDMA transceiver 135. Accordingly, the CDMA diversity antenna 165 may act as the main receiving element of the CDMA antenna arrangement 155 during the voice call operation to improve isolation between the transmission and reception of data during the SV-LTE operation.

In 435, a determination is made whether the voice call operation and the data mode operation are still being performed. If the voice call operation and the data mode operation are still being performed, the method 400 returns to 425 in which the second position arrangement 300 is maintained. However, if the both the voice call operation and the data mode operation are no longer being performed concurrently, the method 400 continues to 440. In 440, the processor 110 determines whether the transceiver is still required. For example, a further communication type operation that utilizes the data mode operation only may still be running Thus, the method 400 returns to 415. However, if no further communication type operation is being executed, the method 400 ends. It should be noted that the method 400 may be reinitialized or used whenever a communication operation is performed.

It should be noted that the method 400 may include further steps. For example, after 405, the switch control application may also determine which phase the operation is currently performing. As discussed above, the SV-LTE operation may utilize the first position 200 arrangement for an initial association process (e.g., handshake). Accordingly, the method 400 may determine that this phase requires the first position arrangement 200. The method 400 may return to determine that a subsequent phase is being performed at a later time in which the second position arrangement 300 may be used. In another example, the method 400 may include a step to determine which position the switch 170 is at currently. For example, prior to 415 or prior to 425, this step may be used. Thus, if the switch 170 is in the proper position, the method 400 may simply maintain the position whereas if the switch 170 is in the other position, the method 400 may include the processor 110 generating the signal to change the position to the proper position.

The exemplary embodiments provide a transceiver and an antenna arrangement in which the isolation may be improved between transmission and reception of signals, particularly when a second transceiver is also used concurrently. The transceiver may include a main transmitting component, a main receiving component, and a diversity receiving component while the antenna arrangement may include a main antenna, a diversity antenna, and a switch. The switch may be in a first position such that the main antenna is connected to the main receiving component. In this manner, the diversity antenna may provide conventional functionalities of improving the receiving of data. The switch may also be in a second position such that the diversity antenna is connected to the main receiving component. In this manner, the diversity antenna may be used as a main receiving component of the antenna arrangement such that the isolation between the transmission and reception of signals in a voice application may be increased, thereby decreasing an intermodulation product from the result of a further transceiver being utilized concurrently.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. An antenna configuration for an electronic device, comprising:
a main antenna coupled to a transmit communication path;
a diversity antenna; and
a switch controller operating to:
route a receive communication path to a main receiving component of a transceiver from the main antenna when the electronic device is operating in a first operational mode; and
route the receive communication path to the main receiving component of the transceiver from the diversity antenna when the electronic device is operating in a second operational mode.

2. The antenna configuration of claim 1, wherein the switch controller is further operable to:
route a further receive communication path to a diversity receiving component of the transceiver from the diversity antenna when the electronic device is operating in the first operational mode; and
route the further receive communication path to the diversity receiving component of the transceiver from the main antenna when the electronic device is operating in the second operational mode.

3. The antenna configuration of claim 1, wherein the first operational mode is a one of a data-only mode operation, a voice call-only mode operation, and an open loop mode operation during an initial registration of a voice call and the second operational mode is the simultaneous data mode and voice call operation.

4. The antenna configuration of claim 3, wherein the simultaneous data mode and voice call operation is a Simultaneous Voice (SV) and Long Term Evolution (LTE) application.

5. The antenna configuration of claim 4, wherein the data mode portion of the data mode and voice call operation is performed on at least one of Band Class (BC) 13 and 14 and the voice call portion of the data mode and voice call operation is performed on BC0.

6. The antenna configuration of claim 1, wherein the main antenna transmits and receives signals and the diversity antenna receives signals.

7. The antenna configuration of claim 1, wherein the switch controller operates a radio frequency (RF) switch to route the receive communication path.

8. The antenna configuration of claim 7, wherein the RF switch is a double pole double throw switch.

9. The antenna configuration of claim 1, wherein the transmit communication path is routed to a main transmitting component of the transceiver to the main antenna.

10. A method for configuring an antenna of an electronic device, comprising:
routing, by a switch controller, a receive communication path to a main receiving component of a transceiver from a main antenna when the electronic device is operating in a first operational mode, the main antenna being coupled to a transmit communication path; and
routing, by the switch controller, the receive communication path to the main receiving component from a diversity antenna when the electronic device is operating in a second operational mode.

11. The method of claim 10, further comprising:
routing, by the switch controller, a further receive communication path to a diversity receiving component of the transceiver from the diversity antenna when the electronic device is operating in the first operational mode; and
routing, by the switch controller, the further receive communication path to the diversity receiving component of the transceiver from the main antenna when the electronic device is operating in the second operational mode.

12. The method of claim 10, wherein the first operational mode is one of a data-only mode operation, a voice call-only mode operation, and an open loop mode operation during an initial registration of a voice call and the second operational mode is a simultaneous data mode and voice call operation.

13. The method of claim 12, wherein the simultaneous data mode and voice call operation is a Simultaneous Voice (SV) and Long Term Evolution (LTE) application.

14. The method of claim 13, wherein the data mode portion of the data mode and voice call operation is performed on at least one of Band Class (BC) 13 and 14 and the voice call portion of the data mode and voice call operation is performed on BC0.

15. The method of claim 10, wherein the main antenna transmits and receives signals and the diversity antenna receives signals.

16. The method of claim 10, wherein the switch controller operates a radio frequency (RF) switch to route the receive communication path.

17. The method of claim 16, wherein the RF switch is a double pole double throw switch.

18. The method of claim 10, wherein the transmit communication path is routed to a main transmitting component of the transceiver to the main antenna.

19. An antenna configuration of an electronic device, comprising:
an antenna arrangement including:
a main transmit and receive antenna; and
a secondary receive-only antenna; and
a radio frequency (RF) switch operating to:
route a first receive communication path from the main antenna to a main receiving component of a transceiver and route a second receive communication path from the secondary antenna to a diversity receiving component of the transceiver when the electronic device is operating in a first operational mode; and
route the first receive communication path from the secondary antenna to the main receiving component of the transceiver and route the second receive communication path from the main antenna to the diversity receiving component of the transceiver when the electronic device is operating in a second operational mode.

20. The antenna configuration of claim 19, wherein the first operational mode is a data mode operation and the second operational mode is a simultaneous data mode and voice call operation.
